(19) United States
(12) Patent Application Publication
(10) Pub. No.: US 2003/0006990 A1
(43) Pub. Date: Jan. 9, 2003

(54) Surface mapping and 3-D parametric analysis

(76) Inventors: Lawrence Steven Salant, New Hempstead, NY (US); Roland Gamper, Geneve (CH)

Correspondence Address: Gordon Kessler, FROMMER LAWRENCE & HAUG LLP, 745 Fifth Avenue, New York, NY, 10151, US

(21) Appl. No.: 10/155,655

(22) Filed: May 24, 2002

Related U.S. Application Data
(60) Provisional application No. 60/294,921, filed on May 31, 2001.

(51) Int. Cl. G09G 5/22; G06T 11/20

(52) U.S. Cl. 345/440.1

(57) ABSTRACT

A display for displaying acquired waveforms from an oscilloscope. An x-axis measurement designating time during an acquisition trace, a y-axis measurement designating one or more acquisition traces, and a z-axis measurement designating an amplitude at at least one point of one or more of the acquisition traces are provided. The z-axis is indicated by a color difference, thereby displaying a surface map.

### CROSS REFERENCE TO RELATED APPLICATIONS

This application claims the benefit of Provisional Patent Application Serial No. 60/294,921, filed May 31, 2001.

### BACKGROUND OF THE INVENTION

Digital Storage Oscilloscopes (DSO's) capture an electrical signal and traditionally allow the user to view a trace of the captured signal in a time (x-axis) verse amplitude (y-axis) display. In addition to merely allowing for the viewing of the signal trace, DSO's also have the capability to perform mathematical processing on the captured waveform. This processing can transform the entire waveform, or can determine certain signal properties automatically, using the captured signal parameters and other preselected parameters for the processing. These automated measurements were traditionally displayed as individual values on the DSO's screen associated with a particular signal trace. When looking at a single feature of a particular captured signal (e.g. rising edge of a signal) or a single waveform the display of each of the values individually on the screen is a valuable tool. However, to analyze a large number of features and/or waveforms, this simple display scheme is inapplicable. Additional tools were needed. To provide this additional analysis capability histogram and trend functions were added to oscilloscopes.

The histogram math function enhances understanding of the distribution of measured parameters, visually and graphically. A histogram can identify the type of statistical distribution in the waveform, helping to establish whether signal behavior is as expected or not. Distribution tails or extreme values related to noise, or other infrequent, non-repetitive sources, can also be observed. Revealed, too, by histograms are frequencies or amplitudes that help in identifying and quantifying jitter and noise so that it can be removed.

Histograms graph the statistical distribution of a parameter's set of values. A histogram bar chart is divided into intervals, or bins. The height of each bar in the chart is proportional to the number of data points contained in each of its bins: the higher the bar, the more points there are in those bins and in the area of the waveform they represent.

The Trend math function visualizes the evolution of a parameter over time in the form of a line graph. The graph's vertical axis is the value of the parameter; its horizontal axis the order in which values were acquired. Alternately, the horizontal axis can be in units of time, as is done in the Jitter & Timing Analysis Package.

### OBJECTS OF THE INVENTION

It is therefore an object of the present invention to provide an improved oscilloscope that allows a user to view a plurality of calculated values with ease.

Still other objects and advantages of the invention will in part be obvious and will in part be apparent from the specification and the drawings.

### SUMMARY OF THE INVENTION

With LeCroy brand oscilloscopes configured for calculation and generation of Histograms or Trends, parameter values are calculated in accordance with a selected function and the chosen function is applied to each subsequent acquisition. The Histogram or Trend values themselves are calculated immediately following each acquisition. The result is a waveform of data points that can be used the same way as any other waveform. Other parameters can be calculated on it. And it can be zoomed, serve as the x or y trace in an XY plot, or used in cursor measurements.

Therefore, in accordance with the invention a user can more easily view trends presented by a sequence of acquired measurements.

The invention accordingly comprises the several steps and the relation of one or more of such steps with respect to each of the others, and the apparatus embodying features of construction, combinations of elements and arrangement of parts that are adapted to effect such steps, all as exemplified in the following detailed disclosure.

### BRIEF DESCRIPTION OF THE DRAWINGS

For a more complete understanding of the invention, reference is made to the following description and accompanying drawings, in which:

FIG. 1 is a surface map in accordance with the invention;

FIG. 2 is a surface map employing a segmented mode in accordance with the invention;

FIG. 3 is a surface map after a disk drive filter has been applied to an acquired signal, in accordance with the invention;

FIG. 4 is a surface map and horizontal slice of the surface map at a desired location thereof, in accordance with the invention;

FIG. 5 is a surface map display including a latest FFT acquisition; and

FIG. 6 is a surface map of disk drive sector data showing variations in data field.

### DETAILED DESCRIPTION OF THE PREFERRED EMBODIMENTS

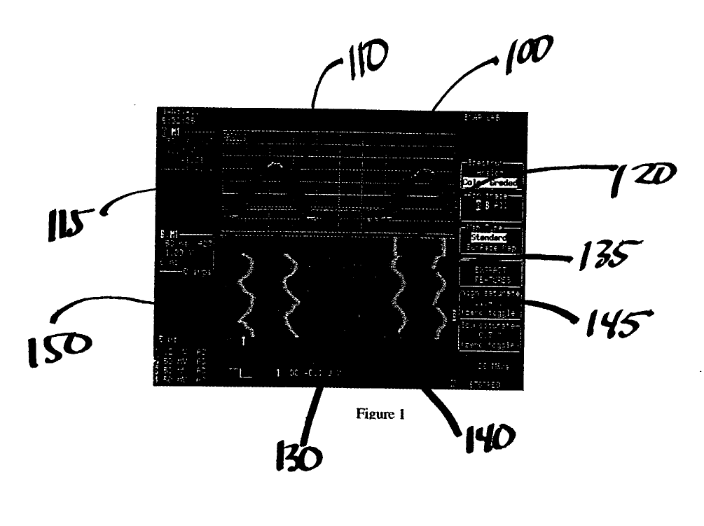

Referring first to FIG. 1, a first embodiment of the invention will be described.

In accordance with the invention, in some applications, such as ultrasound, magnetic scanning, sonar, lidar, radar, etc., the acquired signal is the signal that was previously transmitted, and has bounced off (been reflected by) the surface of the material of interest. As the surface is scanned, an image of the surface can be created by plotting the reflections or echo on successive display lines and variations in the texture of the surface can be examined. In an upper grid 100 of FIG. 1, a series of acquired waveforms 110 are plotted with amplitude on Y axis 15 and time on X axis 120 using persistence mode commonly found in DSO's. Thus, these waveforms are overlaid on top of each other. As is shown, viewing of these waveforms is difficult, and discerning trends from them is impossible. In a lower grid 130, the same data is plotted as a “Surface Map” 135 in accordance with the invention. That is, as each waveform is acquired it is plotted with time on an X axis 140, an the amplitude in the Z axis 145 (which can be seen as a color or greyscale proportional to the amplitude of the waveform at the given time). The Y axis position 150 is incremented after the waveform is drawn and therefore represents time also, but not time during a particular trace, but rather time between consecutive traces.

In accordance with an alternative embodiment of the invention, if there are more data points in the waveform than pixels across the horizontal axis of the grid, the waveform is decimated. Thus, every nth point is displayed where n is determined by total # of points/# of pixels in the grid. Alternatively, a number of associated data can be binned and the peak or average value of the pixels contained in the bin can be used to determine the intensity to be displayed for the number of associated pixels. When the display line with lowest Y value in the grid is filled, the oldest waveform is discarded and others shifted up (y incremented by 1) to allow the newest waveform to be drawn at y=0.

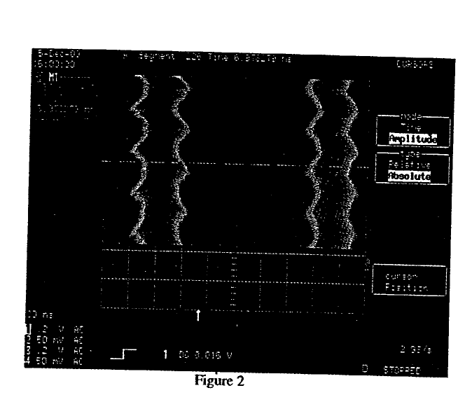

Referring next to FIG. 2, in accordance with an additional embodiment of the invention, for applications where the viewing of more data is desired, a sequence mode may be used to capture the desired number of waveforms or “horizontal lines” to be used in the surface map up to the maximum number of segments acquirable by the DSO. All of these acquired segments, or data traces are stored by the DSO, whether they may all be displayed simultaneously or not. Thus, as long as memory is available, the DSO stores the traces without discarding. In such a segmented mode, the first segment is drawn at the largest Y value as horizontal line with time on the X axis and amplitude on the Z axis as before. The second segment is drawn at y-1, and so forth until all the segments are drawn or the grid is filled. If there are more segments than grid lines, the display is able to scroll forward and backward to view a subset of the stored data. Upon scrolling, the older waveforms are not lost as the later waveforms are viewed. Furthermore, in sequence mode, the absolute amplitude cursors can be used to measure time from the first segment. As shown in FIG. 2, the trigger time of the segment under the bar cursor is shown in the trace descriptor, 6.978279 ms in our example. Additionally, the trace ID, the segment index and time are shown in the message window for a brief time.

Once such a surface map has been plotted, a “cut” along any line in the display allows for quantitative measurement of the amplitude or other values of the surface map. Thus, for example, a cut across acquisitions would give measurements of a cross-section of the object being viewed. Other cuts may also be available, and would provide similar measurement abilities.

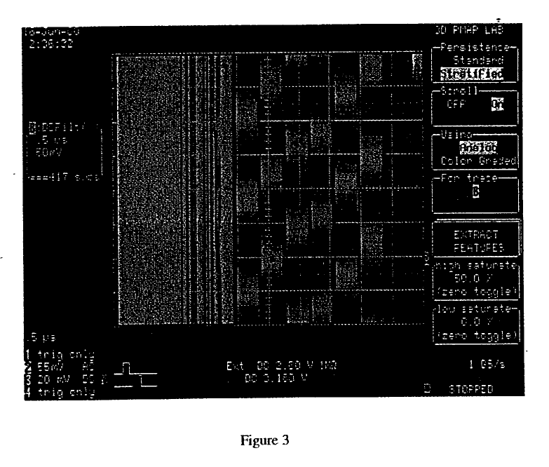

In addition to mapping acquired data, in accordance with a third embodiment of the invention, a surface map can be plotted after it has been processed. For example, such a surface map may be filtered, transformed to the frequency domain, multiplied by another trace, etc. FIG. 3 shows a surface map after a disk drive filter (Lecroy's DDFilt, for example) has been applied.

Furthermore, in accordance with the invention, it is useful to create a trend of n parameter values and then compare it to subsequent trends of the same parameters in order to analyze large amounts of data for patterns, infrequent changes or errors or to generate a “picture” of a physical data packet, changes in the echo of radar or ultrasonic pulse, or changes in pulse width of data bits within a sector or between tracks of a disk drive. To simplify this analysis, the parameter of interest can be shown in 3D by plotting the trend of the parameter as a surface map in accordance with the invention. In this case, the input waveform is analyzed and for each occurrence of a particular desired feature (e.g. pulse width or edge), a measurement is made and added to the trend. The trend is then drawn with the X axis indicating which feature in the waveform (or time if a Jitter Track is used) and the Z axis represents the amplitude of the parameter measurement. As before, the Y axis is incremented for each acquisition to show variations of a given feature over time.

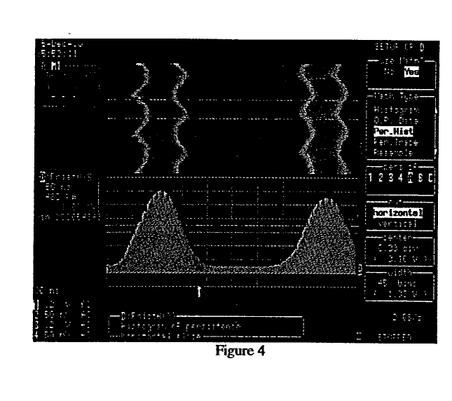

Besides the time cursor mentioned above, a histogram of persistence (Lecroy' PerHist function) function can be used to make quantitative measurements on a surface map generated in accordance with the invention. FIG. 4 shows a horizontal cut of the surface map. Parameters, cursors or further computation could be performed on the PerHist trace.

The implementation of the invention allows the user to create an independent surface map for each channel and processed trace in a DSO.

A saturation control, shown in FIG. 3 is provided to control the amplitude-to-color mapping which permits different features of interest to emerge. The saturation setting allows a better view of all, or only a portion of the data. The “High saturation” defines the threshold above which all amplitudes will be red. Conversely, the “Low saturation” defines the threshold under which all amplitudes will be violet. The saturation control allows the allocation of colors to a segment of the amplitude range in which interesting features can be found, therefore allowing for a more detailed view of the values falling within a particular range. The same data viewed at different saturations, can yield different clues. As is shown in FIG. 4, the % saturation refers to the 16 bit full range of the ADC, 0 to 65536. A high saturation of 62.3% means that all amplitude values about 40829 will map to the red color. Conversely, a low saturation value of 22.9% means that all amplitude values below 15007 will map to the violet color. In an additional embodiment of the invention, saturation may be displayed as a range of the physical units of the source trace.

In accordance with the invention, an example of an oscilloscope constructed in accordance with the invention includes, by way of example only, the following features. A three-dimensional display of up to 6,000 acquisitions for the analysis of time varying data. Amplitude (Z-axis) mapping using up to 64 color levels between user saturation limits. Surface map time, frequency, or jitter phenomenon to study changes over long term duration. Continuous display of dynamic variations such as data patterns, reflective ranging, load variations and imaging. Continuous updating for concurrent adjustment of measured phenomenon. In accordance with these features, the purpose of the surface map generated in accordance with the invention is to provide a unique waveform display mode that shows an evolution of waveform variations over time. Surface maps use each horizontal line of pixels on the DSO screen to depict separately captured waveforms. The amplitude of the waveform is denoted by color, or grey scale value. Highest peaks are preferably in red and lower signal levels are in violet. If a peak is moving, the red pixel changes position from one line to the next. The surface of this three-dimensional surface map shows signal modulation, jitter and other effects in a single view. Surface map images can be made from voltage vs. time waveforms, from FFT's or other types of data.

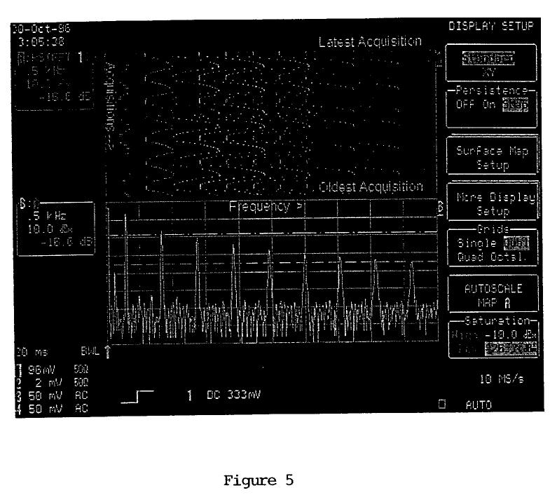

FIG. 5 shows an example of a surface map display of an FFT. The lower display shows the latest FFT, which corresponds to the top line of the surface map in the upper display. It is easy to see the variation in signal frequency and to determine, by observation that the variation is exponential in nature. The surface map in accordance with the invention features an ideal way to view signal variations in applications such as echo ranging (radar, sonar, lidar, ultrasound), packetized serial data streams (magnetic storage and network communications), and control system dynamics (power supplies, automatic gain and frequency controls, phase lock loops). It can be used with time domain, frequency domain or jitter functions.

Each surface map application includes a saturation feature allowing for better control of color amplitude mapping, as noted above. A high saturation level identifies the threshold above which all amplitudes will be red, while a low saturation level identifies the threshold under which all amplitudes will be violet. The saturation control allows the allocation of colors to a segment of the amplitude range in which interesting features can be found. The same data viewed at different saturation levels can yield different clues, allowing the user to see the three-dimensional view of the display traces over time. Engineers benefit from viewing a continuous display of dynamic variations like data patterns, reflective ranging, load variations, and imaging. An auto scale button may also be provided that sets the saturation levels for the data set observed within the grid.

In a segmented mode, which is the preferred mode in accordance with the invention, each segment of the acquired waveform is presented on one line of the display up to the maximum number of segments acquired. As many segments as there are lines in the grid of the display can be plotted and a mechanism is provided to allow comfortable viewing of a window of segments within an entire waveform. More of the waveform may be stored than can be viewed. Thus, as noted above, this allows waveforms to be analyzed, computed upon, stored and recalled.

In a non-segmented mode, each trace is plotted on one line within a group display grid. Each subsequent acquisition causes the next line to be painted and there is no memory of the past traces other than colored pixels in the grid of the display. When the filling processes reach the bottom of the grid, the surface map starts to scroll upwards. The earliest lines scroll off the top of the grid. Only the number of waveforms corresponding to the number of lines in the grid are plotted. Features including storage or non-storage of wave traces not displayed may be provided.

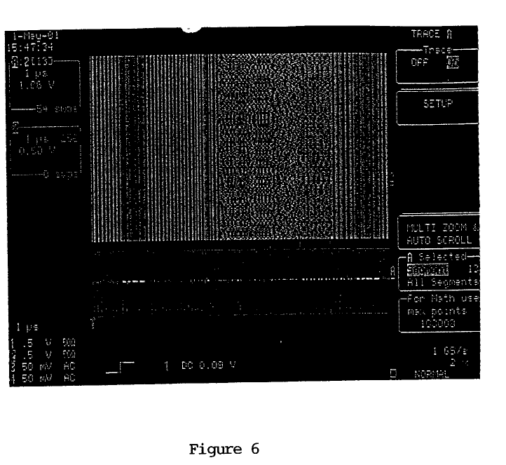

In FIG. 6, a surface map of a series of 250 acquisitions of disk drive sector data is displayed The data has been acquired in sequence mode for minimum dead time between acquisitions. All fields of the sensor data are held constant except for the data field. Vertical lines in the surface map indicate no change in data. Changes-show-up as broken vertical lines. Because this data is digital, the color variation would be limited to two basic colors. Therefore, whether reading digital or analog data, a proper three-dimensional surface map can be provided.

It will thus be seen that the objects set forth above, among those made apparent from the preceding description, are efficiently attained and, because certain changes may be made in carrying out the above method and in the constructions set forth without departing from the spirit and scope of the invention, it is intended that all matter contained in the above description and shown in the accompanying drawings shall be interpreted as illustrative and not in a limiting sense.

What is claimed is:

1. A display for displaying acquired waveforms from an oscilloscope, comprising:
an x-axis measurement designating time during an acquisition trace;
a y-axis measurement designating one or more acquisition traces; and
a z-axis measurement designating an amplitude at at least one point of one or more of said acquisition traces; wherein said z-axis is indicated by a color difference, thereby displaying a surface map.

2. The display of claim 1, wherein each acquisition trace is displayed after decimation.

3. The display of claim 1, wherein each acquisition trace is displayed after binning the values thereof.

4. The display of claim 3, wherein a peak value of said binned values is displayed.

5. The display of claim 3, wherein an average value of said binned values is displayed.

6. The display of claim 1, wherein a selected number of acquisition traces are displayed out of a plurality of acquisition traces stored by said oscilloscope.

7. The display of claim 1, wherein said surface map is processed before being displayed.

8. The display of claim 1, wherein a trend of a predetermined number of parameter values is created and compared to a subsequent trend created of the same predetermined number of parameter values.

9. The display of claim 1, further comprising a saturation control, said saturation control defining a high saturation amplitude value and a low saturation amplitude value between which all available colors are displayed.

10. The display of claim 1, wherein said surface map displays voltage versus time waveforms.

11. The display of claim 1, wherein said surface map displays an FFT (fast fourier transform).

12. A method for displaying acquired waveforms from an oscilloscope, comprising:
displaying an x-axis measurement designating time during an acquisition trace;
displaying a y-axis measurement designating one or more acquisition traces; and
displaying a z-axis measurement designating an amplitude at at least one point of one or more of said acquisition traces; wherein said z-axis is indicated by a color difference, thereby displaying a surface map.

13. The method of claim 12, wherein each acquisition trace is displayed after decimation.

14. The method of claim 12, wherein a selected number of acquisition traces are displayed out of a plurality of acquisition traces stored by said oscilloscope.

15. The method of claim 12, wherein said surface map may be processed before being displayed.

16. The method of claim 12, wherein a trend of a predetermined number of parameter values is created and compared to a subsequent trend created of the same predetermined number of parameter values.

17. The method of claim 12, further comprising the step of:
providing a saturation control, said saturation control defining a high saturation value and a low saturation value between which all available colors are displayed.

18. The method of claim 12, wherein said surface map displays voltage versus time waveforms.

19. The method of claim 12, wherein said surface map displays an FFT (fast fourier transform).

20. A surface map displayed on a display, comprising:
an x-axis measurement designating time during an acquisition trace from an oscilloscope;
a y-axis measurement designating one or more of said acquisition traces; and
a z-axis measurement designating an amplitude at at least one point of said one or more acquisition traces; wherein said z-axis is indicated by a color difference.

21. The surface map of claim 20, wherein one or more predetermined measurements are made along a cut in said surface map.

22. The surface map of claim 21, wherein said predetermined measurements comprise amplitude.
